(19) United States
(12) Patent Application Publication
(10) Pub. No.: US 2019/0308861 A1
(43) Pub. Date: Oct. 10, 2019

(54) Countertop Installation Cart

(71) Applicant: Clinton Dean Reagle, Grove City, OH (US)

(72) Inventor: Clinton Dean Reagle, Grove City, OH (US)

(21) Appl. No.: 16/373,802

(22) Filed: Apr. 3, 2019

Related U.S. Application Data
(60) Provisional application No. 62/652,958, filed on Apr. 5, 2018.

(51) Int. Cl. B66F 9/22; B66F 9/18; B62B 3/06

(52) U.S. Cl. CPC B66F 9/22; A47B 77/022; B62B 3/0618; B66F 9/18

(57) ABSTRACT

An installation cart is provided. The cart includes a hydraulic pump that when activated permits a load placed in a lifting cradle of the cart to be vertically raised and/or lowered on the cart. The cart is does not require electrical or gas power for operation and can raise and lower loads placed in the cart for transport weighing in excess of 800 pounds. In an embodiment, the cart includes a clamping mechanism that adjustably allows a load placed in the cradle to be stabilized during transport of the load.

### RELATED APPLICATIONS

The present application is a non-provisional application of and claims priority to U.S. Provisional Application No. 62/652,958 filed on Apr. 5, 2018, entitled “Countertop Installation Cart,” the disclosure of which is incorporated by reference herein in its entirety.

### BACKGROUND

Granite fabrication companies utilize manual lifting when installing large countertop pieces of granite. Several individuals are needed during this process to carry pieces of granite weighing, in some cases, several hundred pounds.

Not surprisingly, there are injuries during the process, which results in employees being off from work and employers paying workman compensation and health care for the injured workers.

Additionally, the granite pieces can be damaged during a drop, which can also damage the property of the customer paying to have the granite pieces installed. Custom pieces of granite have to be remanufactured in these circumstances and customers reimbursed for any damage to their property. Furthermore, the timeline for the installation may have to be delayed while waiting for the new customer pieces of granite to be remanufactured for installation. Customers become displeased and may not recommend or user the company that was hired to perform the installation. Still worse, customers may actively tell others not to use the company.

There are some granite lift carts available in the industry; however, very few are actually used because of the limitations of such carts and because of the added expense associated with buying or renting such carts.

Therefore, what is needed is an improved countertop installation cart.

### BRIEF DESCRIPTION OF THE DRAWINGS

FIG. 1A illustrates a front view of a cart, according to an example embodiment.

FIG. 1B illustrates a side view of the cart from the FIG. 1A, according to an example embodiment.

FIG. 2A-2C illustrate granite clamping components of the cart from the FIGS. 1A-1B, according to an example embodiment.

FIG. 3 illustrates another view of the cart from the FIGS. 1A-1B, according to an example embodiment.

### DETAILED DESCRIPTION

The aforementioned problems associated with granite countertop installation and existing lifting carts are resolved with the countertop installation cart described herein and below.

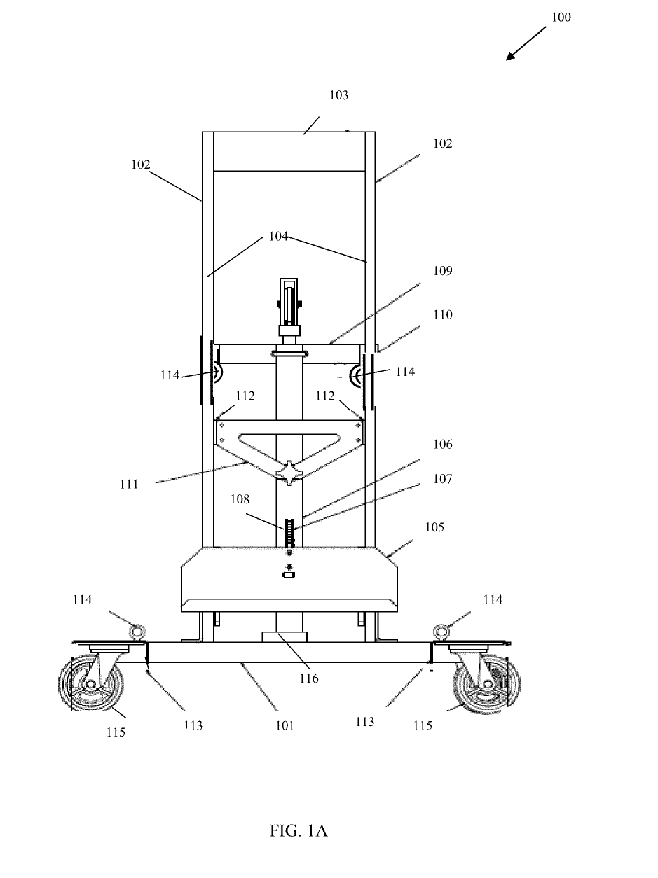

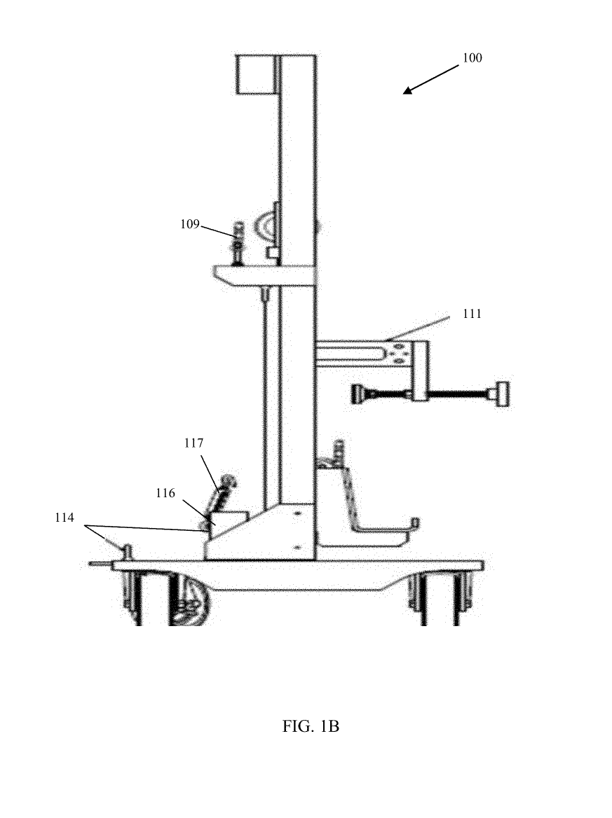

FIG. 1A illustrates a front view of a cart 100, according to an example embodiment. The cart 100 includes a variety of components. It is noted that only those components necessary for understanding the cart 100 are labeled in the FIGS, and other components that are unnecessary for understanding the novel features of the cart 100 are unlabeled.

The cart 100 includes: a main frame 101 (may also be referred to herein as “horizontal base member 101”), roller guides 102 (may also be referred to herein as “vertical members 102” or “vertical rail members 102”), a roller guide support brace 103, track within roller guides 104 (may also be referred to herein as “track 104”), a cradle 105 (may also be referred to herein as “basket 105”), a hydraulic cylinder pump assembly 106, heavy duty roller chain 107, chain track roller 108, handle with brace support 109, handle mount 110, a clamp assembly 111, clamp slides 112 that slide within the track 104, roller guide support bases 113, eyebolts 114, casters/wheels 115, and a foot pump 116.

As used herein a “load” refers to an object that is being moved, installed from, or removed (unloaded) from the cart 100. The load is placed and removed from the cradle 105. In an embodiment, the load is a granite countertop.

In an embodiment, the length between the roller guides 102 is approximately 16 inches.

In an embodiment, the length that extends from the outer edges of the two roller guide support bases 113 is approximately 40.25 inches.

In an embodiment, the height that extends from the bottom of the casters 115 to the tops of the roller guides 102 is approximately 59.25 inches.

In an embodiment, the height that extends from the tops of the two roller guide support bases 113 to the handle 109 is approximately 30.25 inches.

In an embodiment, a width that extends from the outer edges of the two roller guide support bases 113 when viewing the cart 100 from the side is approximately 20 inches.

FIG. 1B illustrates a side view of the cart 100 from the FIG. 1A, according to an example embodiment. The clamp 111 extends out from the roller guides 102 allowing granite countertops or slabs to be stabilized under the clamp from the cradle 105. The clamp 111 is adjustable vertically upward or downward through clamp slides 112 that move within the track 104 of the roller guides 102.

The hydraulic cylinder assembly 106 is activated and deactivated to raise and lower the cradle 105 via a foot pump 116. That is, as the foot pump 116 is pressed down, the hydraulic cylinder assembly 106 raises the cradle 105 upward while a load (granite countertops or other heavy material) is on the cradle 105. A pressing and holding of the foot pump 116 may cause the hydraulic cylinder assembly 106 to slowly lower the cradle 105 down from a vertically elevated position along the roller guides 102.

The FIG. 1B also more clearly illustrates the handle 109. An operator grasps the handle 109 with a hand to transport by pushing or pulling the cart 100, which moves via the casters/wheels 115. The handle 109 may also be used as a mechanism to stop the cart 100 from moving when the cart 100 includes a load in the cradle 105 or when a load is being added onto the cradle 105 or removed from the cradle 105.

In an embodiment, a second foot pump (not shown in the FIGS.) is used to lower the cradle 105.

In an embodiment, a hand-activated pump (not shown in the FIGS.) is used to lower the cradle 105.

In an embodiment, a hand lever (not shown in the FIGS.) is pumped up and down to raise the cradle 105.

The chain 107 is affixed or interfaced to the back and middle of the cradle 105. The hydraulic cylinder assembly 106 activates the chain 107 through the hydraulic cylinder assembly 106 as the foot pump 116 is pressed thereby moving the chain 107 vertically up through the chain track roller 108 at the top of the hydraulic cylinder assembly 106. The chain 107 lifts the cradle 105 upward. Activation of the same foot pump 116, a separate foot pump (not shown in the FIGS.) and/or a hand-activated pump (not shown in the FIGS.) causes the hydraulic cylinder assembly 106 to reverse the direction of the chain 107 and slowly lower the cradle 105.

The FIG. 1B also illustrates one of the four eyebolts 114. The eyebolts 114 permit strings or ropes to be passed through the holes of the eyebolts to provide added stability and support for a load placed in the cradle 105.

In an embodiment, a turn buckle 117 may be inserted on one end into one of the eyebolts 114. The other end of the turn buckle 117 can then be stretch and hooked onto part of the load or a rope/string to provide another mechanism for stabilizing a load that is in transport on the cart 100.

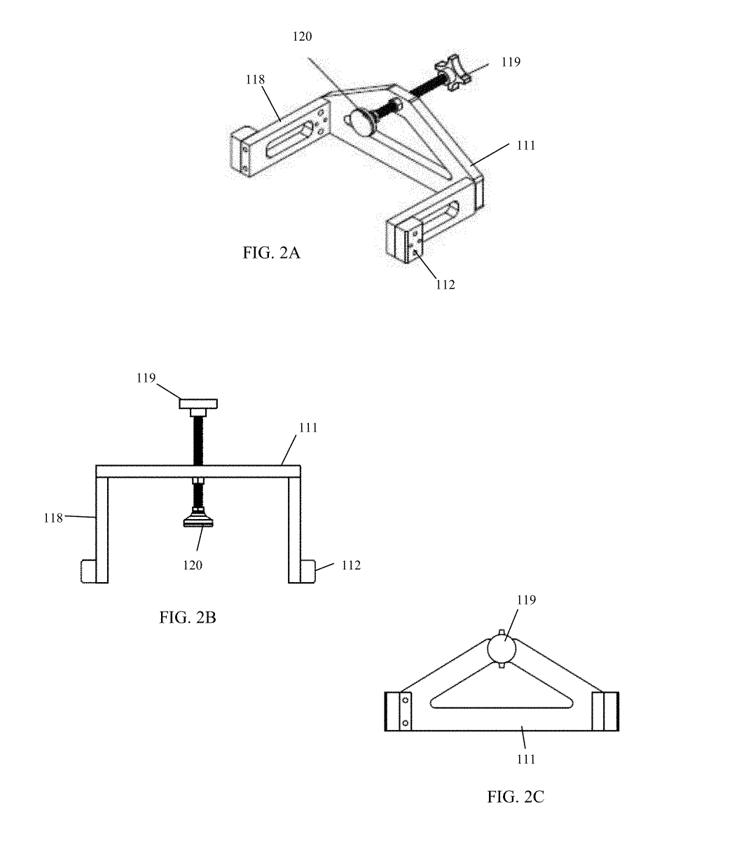

FIG. 2A-2C illustrate granite clamping components of the cart 100 from the FIGS. 1A-1B, according to an example embodiment.

FIG. 2A illustrates the clamping mechanism (clamp) 111 from one side. The clamp 111 includes legs 118 that extend vertically and include the clamp slides 112 on one end. The clamp slides 112 fit inside the track 104 and permit the clamp 111 to be vertically raised and lowered along the roller guides 103. The clamp 111 is oriented perpendicularly to the roller guides 103 as shown in the FIG. 1B when installed on the cart 100. The clamp 111 is attachable and detachable from the track 104 of the roller guides 103.

The clamp 111 also includes a swiveling level mount 120 that is adjusted through a four-arm knob 119. So, when a load is placed under the clamp 111, the knob 119 can be turned to increase and decrease a space/distance between the load and the level mount 120. The load rests on one side against the roller guides 103, the other end of the load is interfaced by the level mount 120, such that as the knob 119 is turned the load is sandwiched between the roller guides 103 and the level mount 120. A snug fit stabilizes the load for transport on the cart 100.

The FIG. 2B shows the clamp 111 in an upright position. The FIG. 2C shows the clamp 111 from a top down perspective, such that just the top of the knob 119 is visible from the angle illustrated in the FIG. 2C.

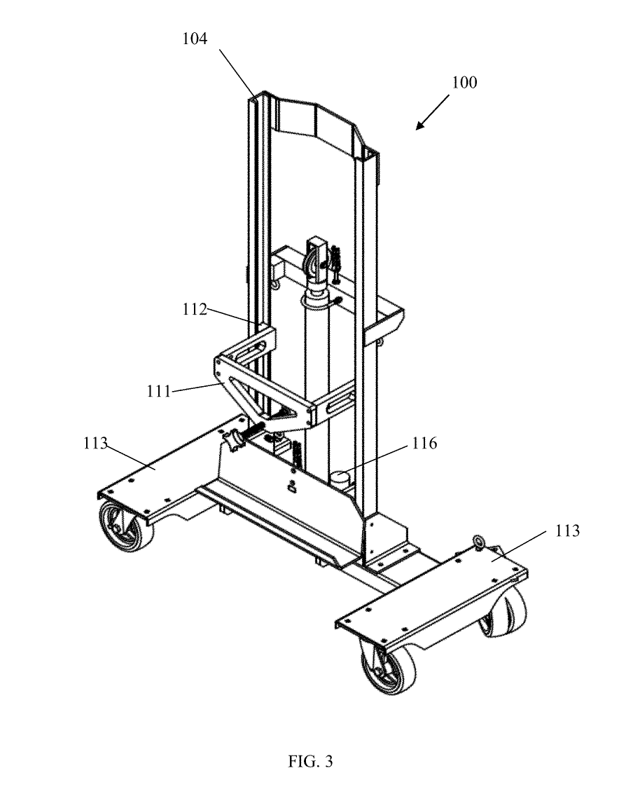

FIG. 3 illustrates another view of the cart 100 from the FIGS. 1A-1B, according to an example embodiment. FIG. 3 shows the width and shape of the roller guide support bases 113 upon which the base of a load rests for transport on the cart 100. When the load is raised through the hydraulic cylinder assembly 106 through the cradle 105 the edges of the load are raised off the roller guide support bases 113, such that the load is solely supported by the cradle 105 when in a raised position. The foot pump 116, which is part of the hydraulic cylinder assembly 106, is also more clearly illustrated in the FIG. 3. Furthermore, the track 104 is visible in the FIG. 3 such that the orientation and movement of the clamp 111 through the clamp sides 112 is discernable.

The cart 100 does not require electrical or gas power to raise and lower a heavy load; rather, a pump-activated hydraulic cylinder assembly 106 is provided which uses a heavy duty chain 107 to raise the cradle 105 vertically. The same pump 116 or a different pump (hand or foot) may be used to lower the cradle 105. Stability of the load is adjustably maintained through the clamp 111 and/or through ropes/strings ran through the eyebolts 114 with or without usage of a turn buckle 117.

The pump 116 is pumped by an operator's foot to cause the hydraulic cylinder assembly 106 to vertically raise or lower a load in the cradle 105. The clamp 111 moves with the cradle 105 as the cradle 105 is raised through the track 104 on the clamp slides 112. The operator reaches a desired vertical height for removing the load from the cart 100. The knob 119 can be turned to disengage the level mount 120 and allow the clamp 111 to be removed from the track 104. The operator or operators can then remove the load and install or place the load at a desired height onto whatever surface that is to receive the load.

In some cases, a load may be taken off a back of a truck or a loading dock at a height above ground level. In such cases, the cart 100 may be used place the load onto the cradle 105 at the desired height. The clamp 111 can be placed in the track 104 and used to stabilize the load on the cradle 105. The foot pump 116 or a separate pump (as discussed above) can then be activated to slowly lower the load back to ground level where the load can be transported via the cart 100 to a desired install location. So, the cradle 105 can be raised while installing a load onto the cart 100 and does not have to be raised only when removing a load from the cradle 105.

In an embodiment, the hydraulic cylinder assembly 106 can raise and lower a load that may exceed approximately 800 pounds.

In an embodiment, an adjustable strapping mechanism that self-winds from a roll is affixed to one of the roller guides 102. The roll is adjustable vertically along the roller guides 102 similar to the clamp 111. A strap can be pulled from the roll and affixed to one or more braces or ran through one or more holes on an opposite roller guide 102 (opposite from the roller guide 102 having the strapping mechanism). The strap can then be ran over a front surface of the load and affixed to the other roller guide 103. Alternatively, the strap may be ran along the backside of the cart 100 and affixed back to a hook or locking mechanism attached to the roll. This provides additional stability and support of the load while the load is in transport on the cart 100.

The casters/wheels 115 may all include locks that prevent the casters 115 from swiveling. When unlocked, the casters 115 can freely spin about the base, and when located the casters 115 are forced to go straight when pushed. In an embodiment, one, two, three, or four of the casters 115 have locks.

The main frame 101 of the cart 100 is constructed of sturdy aluminum and/or steel materials. The roller guide support bases 113 are affixed onto the frame 101 and extend at least the width of the casters 115. The roller guides 102 along with the cradle 105 and the hydraulic cylinder assembly 106 are substantially centered on the frame 101.

The base of the frame 101 is horizontally oriented and the roller guides 102 are attached as vertical members that are perpendicular to the base. The cradle 105 and the clamp 111 adjustably move vertically upward and downward through the track 104. In the case of the cradle 105, vertical movement is activated via the pump 116 and the hydraulic cylinder assembly 106.

The novel cart provides an improved lifting and transport mechanism for heavy objects (such as granite countertops) being installed and transported. The lifting mechanism is achieved through a hydraulic cylinder assembly 106 activated through a foot pump 116 situated at a bottom or base of the hydraulic cylinder assembly 116. The components of the novel cart 100 are made of strong steel, aluminum, or other material so as to withstand the force of the heavy objects being lifted and transported with the novel cart 100 without breaking or bending the components of the cart 100.

1. An installation cart, comprising:
a frame;
two roller guides vertically attached to the frame;
a hydraulic assembly attached to the frame and situated between the two roller guides;
a cradle interfaced to the hydraulic assembly; and
a pump;
wherein the pump when pressed is configured to activate the hydraulic assembly to move the cradle vertically upward and downward along the two roller guides.

2. The installation cart of claim 1 further comprising, a clamp configured to be inserted into a track that runs through the two roller guides, wherein the clamp is configured to adjustably and vertically move along the track of the two roller guides.

3. The installation of claim 2, wherein the clamp includes a swiveling level mount and an adjustable knob that is configured to adjust a distance between the swiveling level mount and a load placed in the cradle that rests on one side against the two roller guides and on opposing side against the swiveling level mount.

4. The installation cart of claim 3, wherein the clamp includes two legs, each leg including a slide, wherein the slides are inserted into and removed from the track to install and remove the clamp from the two roller guides.

5. The installation of claim 1 further comprising 4 casters/wheels attached to a bottom of the frame.

6. The installation cart of claim 1 further comprising, a handle attached to a brace that extends between the two roller guides and is situated above a top of the hydraulic assembly and is also situated on a back side of the installation cart.

7. The installation cart of claim 1, wherein the pump is interface to a bottom of the hydraulic assembly and is situated on a back side of the installation cart, wherein the pump is configured to be pressed by a foot of an operator of the cart to raise and lower the cradle.

8. The installation cart of claim 1 further comprising, two roller guide support braces attached on top of the frame.

9. The installation cart of claim 1 further comprising, a top brace situated between the two roller guides at substantially near top ends of the two roller guides.

10. An installation cart, comprising:
a horizontal base member;
two vertical members attached to the horizontal base member, each vertical member including a track that runs along an inside of each vertical member;
a hydraulic cylinder assembly that includes a pump and a chain track roller; and
a cradle attached by a chain to the chain track roller and the two vertical members within the track;
wherein the cradle is configured to adjustably move upward and downward along the track of the two vertical members based on activation of the pump that causes the hydraulic cylinder assembly to move the chain along the chain track roller and adjustably raise and lower the cradle.

11. The installation cart of claim 10 further comprising, a clamp that is configured to inserted and removed from the track through clamp slides that insert and remove from the track.

12. The installation cart of claim 11, wherein the clamp includes two legs that extend out from the two vertical members when inserted into the track and are perpendicular to the two vertical members.

13. The installation cart of claim 12, wherein the clamp further includes an adjustable swiveling level mount situated in a center of the clamp, the adjustable swiveling level mount configured to hold or stabilize a load placed in the cradle by securing ends of the load between the two vertical members and the adjustable swiveling level mount.

14. The installation cart of claim 10 further comprising a plurality of eyebolts, each eyebolt including an aperture through which a rope or string can be inserted through.

15. The installation cart of claim 14, wherein at least two eyebolts are attached to the horizontal base member and at least two other eyebolts are attached to the vertical members.

16. The installation cart of claim 10 further comprising at least two casters or wheels affixed to a bottom of the horizontal base member.

17. An installation cart, comprising:
a horizontal frame;
two vertical support rails attached on a top of the horizontal frame;
a movable cradle attached to each of the two vertical support rails; and
a hydraulic cylinder assembly attached on the top of the horizontal frame and to a center and a back of the moveable cradle, wherein the hydraulic cylinder assembly includes a foot activated pump and is situated between the two vertical support rails;
wherein the foot activated pump is configured when pressed by a foot of an operator to cause the hydraulic cylinder assembly to vertically raise or lower the moveable cradle along the two vertical support rails.

18. The installation cart of claim 17 further comprising, a clamp that is configured to move vertically along a track in the two vertical support rails and the clamp is further configured to stabilize a load placed in the cradle during transport of the load or when the load is raised or lowered by the cradle.

19. The installation cart of claim 18 further comprising casters or wheels attached on a bottom side of the horizontal frame and configured to allow the installation cart to roll along a surface when the load is being transported on the installation cart.

20. The installation cart of claim 19 further comprising two horizontal support braces attached between the two vertical support rails, wherein at least one of the two horizontal support braces includes a handle for an operator of the installation cart to roll the installation cart or hold and prevent the installation cart from moving.
